(19) United States
(12) Patent Application Publication
(10) Pub. No.: US 2006/0177229 A1
(43) Pub. Date: Aug. 10, 2006

(54) Regenerating an optical data signal

(75) Inventor: Wolfgang Hilgers, Mering (DE)

Correspondence Address: STAAS & HALSEY LLP, SUITE 700, 1201 NEW YORK AVENUE, N.W., WASHINGTON, DC, 20005, US

(73) Assignee: Siemens Aktiengesellschaft, Munich (DE)

(21) Appl. No.: 11/332,286

(22) Filed: Jan. 17, 2006

(30) Foreign Application Priority Data
Jan. 17, 2005 (DE) 10 2005 002 195.6

(51) Int. Cl. H04B 10/06

(52) U.S. Cl. 398/208

(57) ABSTRACT

The receive power of an optical data signal is converted into an electrical data signal by a photodiode. The electrical data signal is then amplified and supplied to a scanning circuit. The receive power (useful signal and noise) is measured in a measurement and control device and the adjustable scanning threshold is set as a function of the receive power corresponding to a predetermined function.

### CROSS REFERENCE TO RELATED APPLICATIONS

This application is based on and hereby claims priority to German Application No. 10 2005 002 195.6 filed on Jan. 17, 2005, the contents of which are hereby incorporated by reference.

### BACKGROUND OF THE INVENTION

1. Field of the Invention

The invention relates to a method and an apparatus for regenerating an optical data signal, which is converted into an electrical data signal and is fed to a scanning stage with an adjustable scanning threshold.

2. Description of the Related Art

Signal recovery is undertaken during the transmission of amplitude-modulated optical data signals by opto-electrical signal conversion. In this process the optical signal is fed to a photodiode which converts it into an electrical signal, and feeds it, in amplified form, to a scanning stage (threshold value decision maker), which outputs a binary data signal. This arrangement is referred to as a data regenerator. According to the different operating conditions in the transmission system, the data regenerator, in particular the amplifier, must exhibit a large dynamic range as regards to the optical input power.

The optimum setting of the scanning threshold (decision maker threshold) significantly contributes to the quality of the transmission system.

Solutions known previously for setting the scanning threshold use additional auxiliary decision maker arrangements or error correction devices. Both however require significantly more effort.

### SUMMARY OF THE INVENTION

An object of the invention is thus to specify a method which is simple to implement and a corresponding apparatus for regenerating an optical data signal, which converts the optical receive signal in the optimum possible way into a binary data signal.

It is advantageous to adjust the scanning threshold for the optical/electrical converted data signal as a function of the receive power.

If a gain control is available for the electrical data signal, the scanning threshold can be optimally set in accordance with a predetermined logarithmic function.

Even if the gain control is absent, the combination of this logarithmic correction function and a second correction variable determined proportionally to the power of the receive signal can achieve an optimal scanning. The predetermined function can be advantageously stored in the form of a table, with it then also being possible to use correction values which deviate from the logarithmic function.

In the case of an analog design of the measurement and control device and absence of gain control of the electrical data signal, the scanning threshold is optimally set for required conditions, and the scanning threshold is controlled proportionally or the correction function is approximated to the receive power.

Arrangements for regeneration can be implemented in a very wide variety of ways. It is advantageous in such cases for the scanning threshold and/or the comparison value voltage of the scanning stage to be a combination of a threshold offset voltage and a correction voltage.

It is advantageous for a threshold setting arrangement to be available, with which the scanning threshold is optimally set in the case of a defined receive power, and the correction value corrects this scanning threshold in the case of deviations of the receive power. In this way tolerances of the regenerator can be balanced out.

### BRIEF DESCRIPTION OF THE DRAWINGS

These and other objects and advantages of the present invention will become more apparent and more readily appreciated from the following description of exemplary embodiments, taken in conjunction with the accompanying drawings of which:

FIG. 1 is a graph of the probability density allocation of the scanning values,

FIG. 2 is a graph showing determination of the optimal scanning threshold,

FIG. 3 is a graph of measurement values for determining the optimal characteristic line for the scanning threshold,

FIG. 4 is a circuit diagram of a data regenerator with gain control,

FIG. 5 is a circuit diagram of a data regenerator without gain control,

FIG. 6 is a circuit diagram of a data regenerator in a simplified analog design.

### DETAILED DESCRIPTION OF THE PREFERRED EMBODIMENTS

Reference will now be made in detail to the preferred embodiments of the present invention, examples of which are illustrated in the accompanying drawings, wherein like reference numerals refer to like elements throughout.

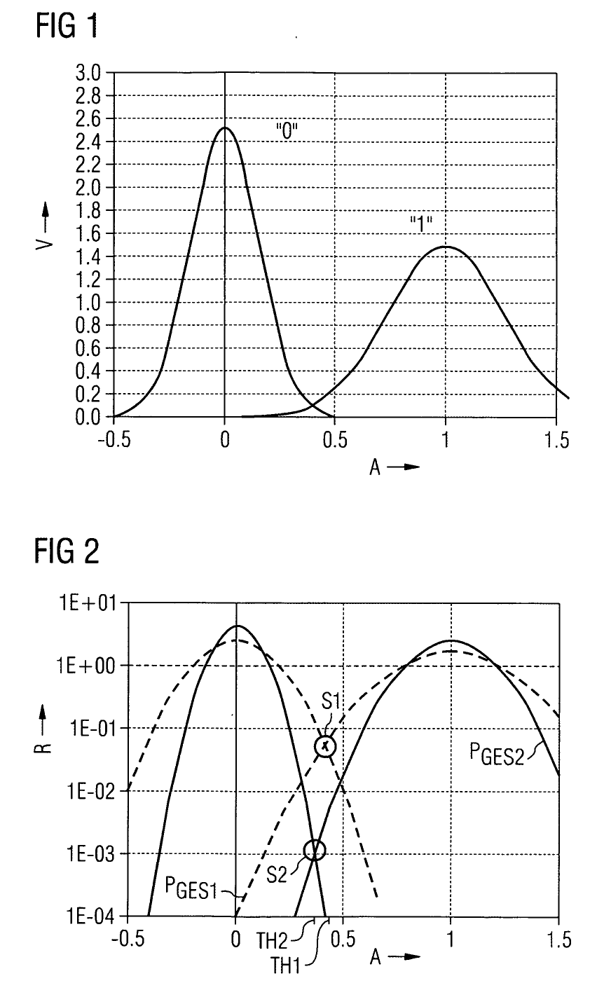

FIG. 1 shows the probability density distribution V of the amplitude A for the two binary signal values “0 and 1” during amplitude modulation. During amplitude modulation, when the logical “0” is sent out the carrier signal is suppressed and is transmitted with the logical “1”. The reason behind the different “quality” of the two binary signal values is an increased noise in the “1-Signal”. The setting of the scanning or decision maker threshold significantly contributes to the quality of the transmission system, which, due to the different proportions of noise in the “0 signal” and in the “1 signal” does not lie at the average value of the amplitudes.

FIG. 2 shows the noise density R at different optical input powers or total powers PGES in the logarithmic scale. The optimally set scanning threshold lies in the point of intersection of the “1 noise density function” with the “0 noise density function”. For low receive power, understood here as the sum of useful signal and optical noise, the influence of the thermal noise of the receive photo diode is greater and a first point of intersection S1 of the functions represented using dots results for the logical “1” and the logical “0”. A lesser OSNR (optical signal-to-noise ratio) results with an increasing optical input power and a decreasing influence of the thermal noise. The optimal scanning threshold thus drops from the first point of intersection S1, which is assigned a first optimal scanning threshold TH1, the threshold corresponding to a lower value TH2 of the curve shown with a continuous curve.

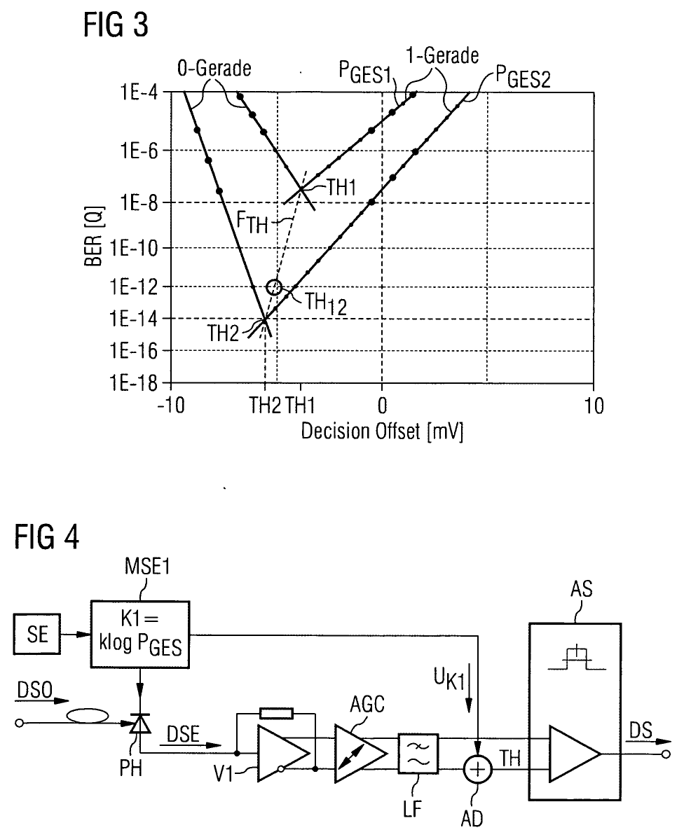

The practical determination of the optimum threshold values is to be explained in more detail with reference to FIG. 3. Together with the useful signal, the different noise sources, in particular optical (ASE) and thermal noise, determine the OSNR and thus essentially the error rate. With a defined OSNR and constant P_{GES1}, the bit error rates (or the OSNR) of the 0 bits and 1 bits are measured in the case of different threshold values. In FIG. 3, these lie on a “0 line” or on a “1 line”. These lines are lengthened (extrapolated) up to their point of intersection. The point of intersection specifies the optimum threshold TH1 for these conditions. Then the power of the useful signal and thus the total optical power is increased, (here by 3 dB). As previously explained, the OSNR reduces and thereby also the expected error rates. A number of measurement points are now likewise determined for the “1 line” and the “0 line” (which comprise lesser error rates due to the lower gain of the gain control, this being apparent from the arrangements described below) and lengthened at a second point of intersection, which specifies the optimum threshold TH2 for the new receive conditions. The connection between the two points of intersection specifies the ideal function F_{TH}=k·logP_{GES} (shown with a dashed line) (k is negative here starting from TH1) for an optimum scanning threshold to be set, which corresponds to a straight line in the logarithmic representation.

FIG. 4 shows the basic circuit diagram of a data regenerator. An amplitude-modulated optical data signal DSO is fed to a photodiode PH, which converts it into an electrical data signal DSE. This signal is amplified in a first amplifier V1 and its amplitude is controlled in a further amplifier AGC (Automatic Gain Control), so that a binary data signal of a constant amplitude is fed to a scanning circuit AS via a lowpass filter LF. The power or amplitude of the received optical data signal DSO is measured in a measurement and control device MSE1. With different amplitude values, the received optical signal and thus also the demodulated electrical data signal DSE thus exhibit a different optical signal-to-noise ratio OSNR. The scanning threshold TH must be adjusted accordingly. To do this, the first correction value K1=k·logP_{GES} is determined and the amplitude is offset by a first corresponding correction voltage U_{K1}, which is added into an adder AD preceding the input of the scanning circuit AS and changes the decision maker threshold. The scanning circuit converts the filtered electrical data signal into a binary data signal DS. The apparatus also includes a threshold adjustment device SE, which intervenes here into the measurement and control device MSE1 and for which there is linear offset, here referred to as the decision Offset, of the characteristic scanning curve FTH from the “neutral threshold” specified with the value “0” in FIG. 3, which corresponds to 0.5 of the amplitude of the electrical data signal DSE.

FIG. 5 shows a data regenerator without a gain control. To this end the measurement and control device must be modified. A second correction factor K2 is determined in addition to the first correction value K1, the second correction value offsetting the scanning threshold as a function of the amplitude of the receive signal by the half of the amplitude change or setting it to 0.5 of the amplitude, in order to scan the electrical data signal DSE in the center. The two correction values are combined in a combiner COM which outputs a correction voltage U_{K2}. The threshold adjustment device SE feeds a voltage corresponding to the offset (FIG. 3), which is combined with the correction voltage U_{K2} into an adder AD. The correction values can be calculated or taken from a table.

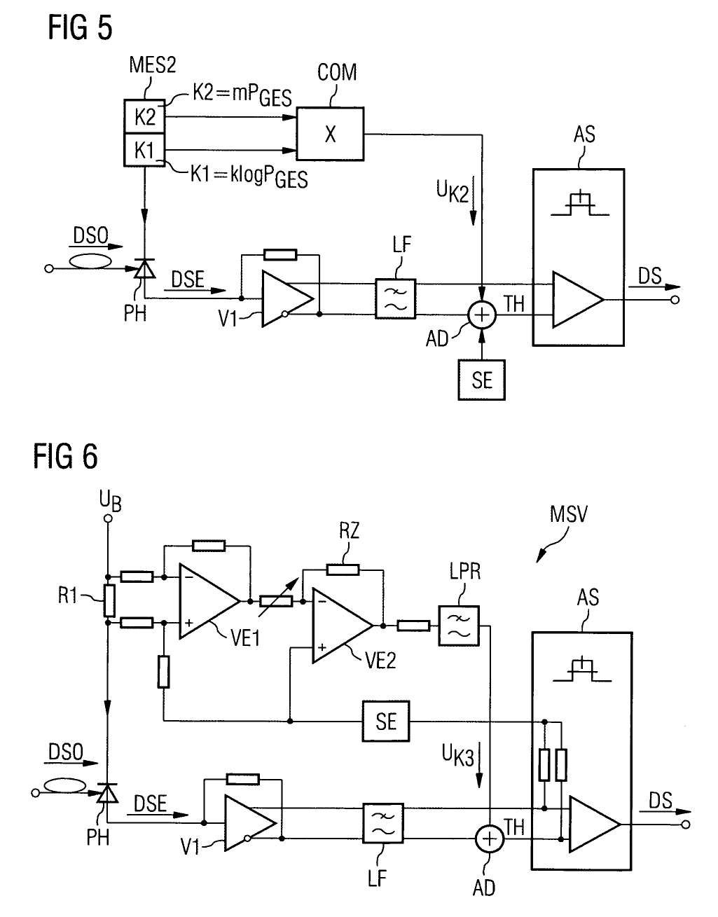

FIG. 6 shows an analog design without a gain control. The measurement and control device MSV is designed in a similar way. The input power is measured at a resistor R1, via which the photodiode PH is connected to a voltage U_{B}. A first differential amplifier VE1 amplifies the voltage dropping at the resistor. A second differential amplifier VE2 with adjustable amplification is arranged downstream of the first amplifier. The reference voltage for the amplifier can be generated in various ways, in this case it is generated by the threshold adjustment device SE in conjunction with output voltages of the low pass filter LF. The threshold adjustment device SE allows a reference threshold TH₁₂ (FIG. 3) to be set, for instance, for the standard conditions of the system, at an error rate of 10⁻¹², for which the system is designed.

In all exemplary embodiments the control takes place slowly in relation to the data rate, in order to be independent of the received bit combinations. In principal this is indicated by a further lowpass filter LPR. If the feedback path RZ of the second amplifier VE2 is designed as a resistor, then the threshold of the scanning circuit is offset linearly with the receive level P_{GES}. If, in contrast, a non-linear element is used in the feedback path RZ, a logarithmic curve of the correction voltage U_{K3} can be achieved (at least approximated).

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1. A method for regenerating an optical data signal, which is converted into an electrical data signal and is fed to a scanning stage with an adjustable scanning threshold, comprising
measuring receive power; and
setting the adjustable scanning threshold using a predetermined function of the receive power.

2. A method according to claim 1, wherein, when gain control for the electrical data signal is available, said setting of the adjustable scanning threshold uses a predetermined logarithmic function of the receive power.

3. A method according to claim 2, wherein, when gain control is unavailable for the electrical data signal, said setting offsets the adjustable scanning threshold proportionally to at least one of power of the optical data signal and amplitude of the electrical data signal.

4. A method according to claim 3,
wherein the predetermined logarithmic function is stored as values in a table, and
wherein said setting of the adjustable scanning threshold includes
reading the values stored in the table corresponding to the receive power; and
converting the values read from the table into correction voltages for the adjustable scanning threshold.

5-7. (canceled)

8. A method according to claim 2,
wherein the predetermined logarithmic function is stored as values in a table, and
wherein said setting of the adjustable scanning threshold includes
reading the values stored in the table corresponding to the receive power; and
converting the values read from the table into correction voltages for the adjustable scanning threshold.

9. A method according to claim 1,
wherein the predetermined function is stored as values in a table, and
wherein said setting of the adjustable scanning threshold includes
reading the values stored in the table corresponding to the receive power; and
converting the values read from the table into correction voltages for the adjustable scanning threshold.

10-12. (canceled)

13. An apparatus for regenerating an optical data signal, which is converted into an electrical data signal in an opto-electronic converter and is fed to a scanning stage with an adjustable scanning threshold, comprising:
a measurement and control device measuring receive power and determining a first correction value, according to a predetermined function of the receive power, to offset the adjustable scanning threshold by a correction voltage based on the first correction value.

14. An apparatus according to claim 13, wherein when gain control is unavailable for the electrical data signal, said measurement and control device additionally determines a second correction value proportional to the receive power and generates the correction voltage used to offset the adjustable scanning threshold based on the first and second correction values.

15. An apparatus according to claim 14, further comprising a threshold adjustment device establishing an optimum setting of the adjustable scanning threshold.

16. An apparatus according to claim 13, wherein the measurement and control device is an amplification device generating the correction voltage, used to offset the adjustable scanning threshold, in proportion to the receive power.

17. An apparatus according to claim 16, further comprising a threshold adjustment device establishing an optimum setting of the adjustable scanning threshold.

18. An apparatus according to claim 14, further comprising a threshold adjustment device establishing an optimum setting of the adjustable scanning threshold.

19. A method according to claim 1, further comprising setting the adjustable scanning threshold to an optimum reference threshold based on standard conditions of a transmission system in which the optical data signal is transmitted.

20. A method according to claim 2, further comprising setting the adjustable scanning threshold to an optimum reference threshold based on standard conditions of a transmission system in which the optical data signal is transmitted.

21. A method according to claim 3, further comprising setting the adjustable scanning threshold to an optimum reference threshold based on standard conditions of a transmission system in which the optical data signal is transmitted.

22. A method according to claim 4, further comprising setting the adjustable scanning threshold to an optimum reference threshold based on standard conditions of a transmission system in which the optical data signal is transmitted.
